(19) United States
(12) Patent Application Publication
(10) Pub. No.: US 2005/0257940 A1
(43) Pub. Date: Nov. 24, 2005

(54) Universal, trimmer line lock system

(76) Inventor: Orlando Jerez, Kenner, LA (US)

Correspondence Address: C. EMMETT PUGH, 82 N. MAIN ST., SUFFIELD, CT, 06078-2102, US

(21) Appl. No.: 10/637,467

(22) Filed: Aug. 8, 2003

Related U.S. Application Data
(60) Provisional application No. 60/402,518, filed on Aug. 9, 2002.

(51) Int. Cl. A01D 15/00

(52) U.S. Cl. 172/13

(57) ABSTRACT

A trimming line segment (100) is attached to a button-like, locking element (200; see FIGS. 5-8 for various embodiments) by inserting their distal tips (101) and adjacent line sections into a pair of holes (201) in the locking element and pulling them through (FIGS. 1A-1C). The distal tips of the line of the assembled line/element (300) are then inserted via the interior into holes in the side wall of a rotatable head, either that provided to house a spool (6) of filament line that has been removed (FIGS. 9A & 9B, and 10) or that of an attachment 20 (FIGS. 12A-D). When the powered, trimming device is rotated, the newly inserted line, held in place by the button-like locking element, then does the cutting and trimming of weeds and the like or even sweeping.

### RELATED APPLICATIONS & PATENTS

This application claims the priority of Provisional Application 60/402,518 filed Aug. 9, 2002 entitled “Cutting Filaments for Weed Cutters,” which incorporated various disclosures, including the inventor's prior application Ser. No. 09/909,032 filed Jul. 19, 2001, and Ser. No. 09/885,374 filed Jun. 19, 2001, with the former being a continuation-in-part of the latter, the disclosures of both of which are incorporated herein, as well as the complete disclosure of said provisional patent application. Although the claims of this application are directed to the line trimmer locking system included as part of the disclosure of the provisional patent application, there are other new aspects as well, and the inventor reserves the right to file one or more divisional applications of this application directed to one or more of the other inventions disclosed in the provisional application.

### TECHNICAL FIELD

The present invention relates to, for example, a preferably universal, lock or holding, attachment system for trimmer line to be attached to hand-held, powered tool either with a very long handle or of a compact, hand-gun-like design or the like, for doing various chores, mostly garden-related, generally characterized in the long handled version as a “Weed-Eater” type of device or in the “hand-gun-like” version as a “power drill”type device, as well as to other rotary drives, including hand-held devices such as powered hand-held rotary drives or power drills such as those that are used to drive drills, screws and the like, as well as perform other types of work with a change of heads or tool ends. More particularly, the locking system of the invention preferably is used in connection with either a specialized or general rotated head device, typically removable from its drive, for locking and holding the trimmer line to the rotated head, which trimmer line typically is consumed during used and needs to be replaced from time to time.

### BACKGROUND ART

The following is a list of patents which may be of interest for at least general background information:

| U.S. Pat. No. | Inventor(s) | Issue Date |
|---|---|---|
| 3,129,771 | Lidstone | Apr. 21, 1964 |
| 3,831,271 | | |
| 4,062,114 | Luick | Dec. 13, 1977 |
| 4,242,794 | Peterson | Jan. 06, 1981 |
| 4,268,964 | Moore | May 26, 1981 |
| 4,286,675 | Tuggle | Sep. 01, 1981 |
| 4,501,332 | Straayer | Feb. 26, 1985 |
| 4,513,563 | Roser et al | Apr. 30, 1985 |
| 4,856,194 | Lee | Aug. 15, 1989 |
| 4,862,682 | Wait et al | Sep. 05, 1989 |
| 4,905,465 | Jones et al | Mar. 06, 1990 |
| 4,962,630 | Jones | Oct. 16, 1990 |
| 5,197,264 | Lacey | Mar. 30, 1993 |
| 5,345,788 | Jerry | Sep. 13, 1994 |
| 5,361,570 | Bernardy | Nov. 08, 1994 |
| 5,426,852 | Macomber | Jun. 27, 1995 |
| 5,430,943 | Lee | Jul. 11, 1995 |
| 5,491,963 | Jerez | Feb. 20, 1996 |
| 5,493,783 | Oostendorp | Feb. 27, 1996 |
| 5,615,543 | Caffey, et al | Apr. 01, 1997 |
| 5,617,636 | Taggert, et al | Apr. 08, 1997 |
| 5,622,035 | Kondo, et al | Apr. 22, 1997 |
| 5,651,418 | Jerez | Jul. 29, 1997 |
| 5,722,172 | Walden | Apr. 03, 1998 |
| 5,761,892 | Quiroga | Jun. 09, 1998 |
| 6,038,842 | Quiroga | Mar. 21, 2000 |
| 6,094,825 | Hinson | Aug. 01, 2000 |
| 6,247,539 | Jerez | Jun. 19, 2001 |
| 6,374,585 | Legrand | Apr. 23, 2002 |

The U.S. Pat. No. 4,513,563 patent discloses a lawn mower rotary assembly where a single filament has an attachment (see FIG. 6) or is looped (see FIG. 9); while the U.S. Pat. No. 4,062,114 patent discloses a single filament for a weed cutter that has an attachment on the end.

The U.S. Pat. No. 6,374,585 patent discloses the concept of two filaments secured in a single hole; while the U.S. Pat. No. 6,094,825 patent discloses a retaining collar for a single strand (see FIGS. 8A & 8B).

Patents U.S. Pat. Nos. 5,197,264, 4,962,630 & 4,905,465 disclose simple loops to retain a single strand in a weed cutter, with the U.S. Pat. No. 4,905,465 patent disclosing the use of multiple holes to loop the strand through.

The U.S. Pat. No. 6,247,539 patent discloses a cultivator implement with castellated cultivating protrusions and a multi-implemented, powered, cultivation system.; while the U.S. Pat. No. 5,651,418 patent discloses a convertible, user-supported, garden cleaning implement for cutting/mascerating weeds; and the U.S. Pat. No. 5,491,963 patent discloses a garden cleaning implement for cutting/mascerating weeds above and below the ground.

In this relatively “crowded” art, the line locking system of the present invention includes substantial, innovative, “unobvious” differences over the prior art, as brought out more fully below, particularly with respect to the claims hereof. It is believed that the present invention represents an innovative, substantial advance in the prior art and a valuable contribution to the “useful arts.”

### GENERAL SUMMARY DISCUSSION OF INVENTION

As previously noted, the present invention relates to, for example, a preferably lock or holding system for trimmer lines to be easily and securely attached to hand-held, powered tool either with a very long handle or of a compact, hand-gun-like design or the like, for doing various chores, mostly garden-related, generally characterized in the long handled version as a “Weed-Eater” type of device or in the “hand-gun-like” version as a “power drill”type device, as well as to other rotary drives, including hand-held devices such as powered hand-held rotary drives or power drills such as those that are used to drive drills, screws and the like, as well as perform other types of work with a change of heads or tool ends. More particularly, the locking system of the invention preferably is used in connection with either a specialized or general, rotated head device, typically removable from its drive, for locking and holding the trimmer line securely to the rotated head so that the line(s) does/do not fall out or get pulled out of their attachment to the rotating head, which trimmer line typically is consumed during used and needs to be replaced from time to time or infrequently, depending on the quality of the trimmer line and the obstacles it might be exposed to during use.

The currently, most preferred embodiments of the present invention are relatively “universal,” that is, the locking elements can be used in connection with, for example, most of the powered, weed trimming devices currently on the market to lock or hold the filament trimmer line to the rotating head of the powered devices.

The exemplary embodiments disclosed herein comprises a number of different devices for replacing, for example, a spool of filament in, for example, a weed cutter.

In one embodiment, the spool of filament in a weed cuter is replaced with one or more, relatively short filaments, each filament being secured with a special, innovative “button” like device. In another embodiment, a special button having two holes of a first diameter and two holes of a second diameter is used to hold the filament (the difference in diameters allows the button to hold twines or lines of different diameters, with thinner twine in the smaller diameter holes and larger twine in the larger diameter holes).

In another embodiment, an easy on-off, anchor-shaped device is used to secure the filament. In another, the filament has secured thereto a cone-shaped member to prevent the filament from sliding through a hole in a weed cutter.

In another embodiment or application, very flexible string is used in a weed cutter to function as a broom.

The currently preferred, trimmer line lock of the invention preferably provides a “universal” method of installing regular trimmer line in order to be inserted into a replacement cutter head attachment, as well as many other conventional trimmer head attachments. The string lock helps protect the head, as well as provide a measure of string security, that is, the trimmer line ideally or preferably will stay in place and not come off or break off until the user determines that it is time for line replacement, particularly in the case of using nylon trimmer line. Also, in some exemplary embodiments described more fully below, the locking elements preferably provide the user with the option to use different size or diameter trimming line or filament.

The string or trimmer lock system can be used in those “other” heads with filament spools but eliminating the need for the bump/spool method of delivering filament or nylon string through their cup/head openings. In this prior art “spool” method the nylon string, typically used in the spool, breaks off easily and does not last at all and string entanglement usually is the result during trimming, as well as when changing the spool.

Other exemplary “heads” with which the embodiments of the present invention include battery operated, electric and gas and even walk behind trimmers.

Using the preferred embodiments of the locking system of the present invention results in longer line, including nylon line, life.

The foregoing and additional features and innovative approaches of the present invention further are disclosed and discussed below.

### BRIEF DESCRIPTION OF DRAWINGS

For a further understanding of the nature, objects, and advantages of the present invention, reference should be had to the following detailed description, read in conjunction with the attached drawings, in which like elements are given the same or analogous reference numbers and wherein:

FIGS. 1A-C are perspective views showing the sequential steps of inserting one segment of trimmer line or filament into one of the exemplary embodiments of the present invention very similar to that shown in close-up in FIG. 5B.

FIGS. 2-4 are side views of three, different, exemplary embodiments of the line trimmer locking system of the present invention, in each of which the trimmer line or filament section is inserted into a pair of closely spaced holes (shown in the subsequent figures) located in each, differently configured locking element, the first being circular, the second being squared off, and the third having a clip-on action, each located at the trimmer line's mid-section, before the distal ends of the trimmer line are inserted into a pair of closely space holes located in the sides of the rotatable head of the, for example, weed trimming apparatus to which the locking system is to be applied, for example, such as those weed trimming, powered devices illustrated in FIGS. 9 & 11, below.

FIGS. 5A & 5B are frontal views of two, similar but different, circular, button-like, locking elements for use in attaching the filament lines to the powered device, for example, a weed trimming apparatus, with the former having two, identical, line insertion holes and the latter having two pair of differently sized diameter, line insertion holes (or, alternatively, four identical diameter holes), for potentially two, separate, different (or, alternatively, identical) line filament segments.

FIG. 6 is a frontal view of an ovally configured, button-like, locking element, similar to the embodiment of FIG. 5A, as still another exemplary embodiment of the present invention, having two identical holes for the insertion of a trimmer line segment.

FIGS. 7A, 7B & 7C are frontal views of three, similar but different, rectangular, button-like, locking elements, as still other exemplary embodiments of the present invention, for use in attaching the filament lines to the powered device, for example, a weed trimming apparatus, with the initial figure having two, identical, line insertion holes in a square, rectangular configuration, the second likewise having two, identical, line insertion holes but in a more elongated, rectangular configuration, and the third having four, identical, line insertion holes in a still further elongated, rectangular configuration, for attaching potentially two separate, line filament segments.

FIG. 8 is a frontal, larger view of a circular, button-like, locking element, similar to the embodiment of FIG. 5B but without the peripheral strengthening ring, as still another exemplary embodiment of the present invention, this one likewise having four, line insertion holes with one pair of holes having a first diameter and the other pair or set of holes having a different diameter of the same size as those of FIG. 5B, likewise allowing the locking element to be used with different sized trimmer line segments having different diameters.

FIGS. 9A & B are perspective views of the working end of an exemplary, “prior art,” hand-held, powered, line filament trimmer unit showing the removal of various standard parts of the unit in preparation for removing the standard filament spool and using its outer, cylindrical body to add segments of trimmer line using the exemplary, trimmer line locking system elements of the present invention.

FIG. 10 is a perspective view, similar to that of FIGS. 9A & 9B, but with the prior art spool of trimmer line completely removed and replaced by trimmer line segments inserted into and attached to the rotatable, outer, cylindrical housing using the button-like locking element of the invention, for example, a circular one like that illustrated in FIGS. 1A-C to lock and hold the trimmer line to the cylindrical housing when rotated at high speed, to, for example, cut weeds and the like.

FIGS. 11A-D are perspective, exploded, “prior art” views showing an exemplary embodiment of a combined cultivator/cutter of the '536 patent being attached to different ones of exemplary types of prior art, hand-held powered devices with an exemplary connection sub-system, including a female-threaded-member (e.g. a nut or female threaded end), a male threaded-member (e.g. bolt or male threaded end) and washer combination, varying in its details for different ones of the hand-held powered devices, a different one of the exemplary powered, hand-held devices being shown in each of these figures. The cutter part of the cultivator/cutter, add-on device exemplifies one exemplary application for the line locking system of the present invention; while

FIG. 11E is a detail, close-up, partial, side view of the bottom cultivator extension of the “prior art” cultivator/cutter of FIGS. 11A-D.

FIG. 12A-D are underside, similar views of a cutter (cultivator) attachment which can be attached to the working end of, for example, a weed trimmer device as generally shown in FIGS. 11A-D but with the cutter (cultivator) attachment of these figures being of a more advanced design and having a multiple series of side-by-side trimmer line openings than the cutter (cultivator) attachment of FIGS. 11A-D, with these figures showing the sequential addition of initially a single filament segment and then progressively to a completed set of filament line segments until are opening are filled with filament line segments each using a locking, button-like embodiment of the present invention to lock or securely hold it to the attachment when it is rotated at relatively high speed by the powered device to, for example, cut weeds and the like.

### EXEMPLARY MODES FOR CARRYING OUT THE INVENTION

### Some, Exemplary Prior Art to which Invention can be Applied

### FIGS. 9A & 9B & FIGS. 11A-E

In the prior art various types of two-hand-held, long handle, powered devices, typically for yard or gardening work are well known, a number of which are of the “Weed-Eater” type. A “Weed-Eater” type of device typically uses a rotating spool of filament at its bottom with a feed bumper (note spool 6 and bumper 7 of FIGS. 21A & B of Patent U.S. Pat. No. 6,247,539, the disclosure of which is incorporated hereby by reference) for cutting grass and the like with the end portions of the filament line, as the spool is rotated about a “vertical” axis.

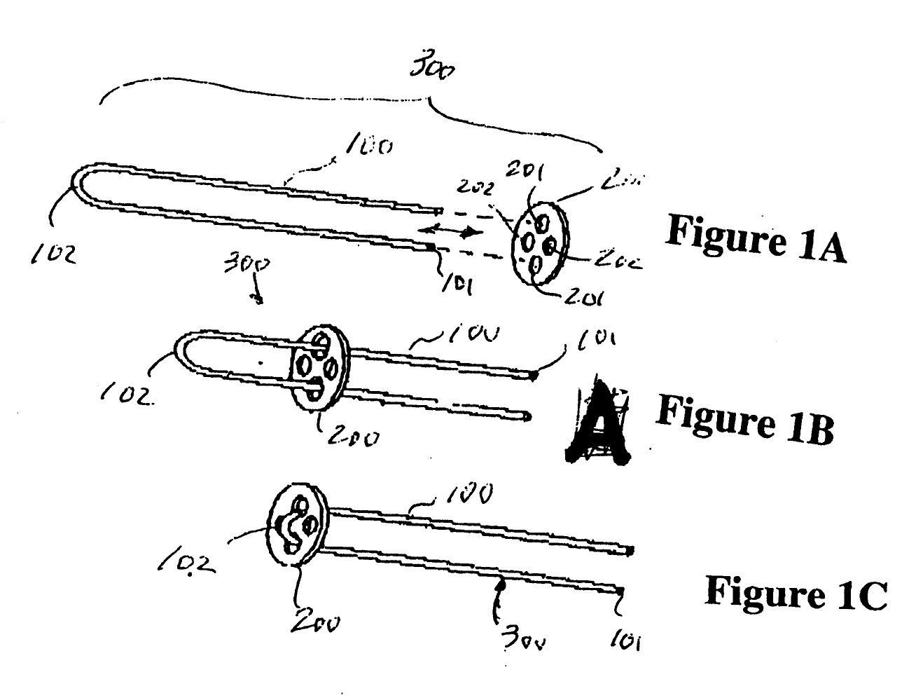

The lengths of the handles of these types of powered devices typically are of the order of a number of feet, typically at least about four to six (4-6′) feet. As can be seen in FIGS. 1A-D of the '539 patent, the bottom ends 2a-2d of these types of devices 1a-1d typically include powered, rotatable, end threaded members, either of the male or female type, for attaching, for example, the filament spool or other implement that came with the original, powered device.

For convenience of reference copies of these drawings are included with this specification as FIGS. 9A & 9B (corresponding to FIGS. 21A & B of the '539 patent) and FIGS. 11A-E (corresponding to FIGS. 1A-D and FIG. 1, respectively, of the '539 patent), with the same reference numbers being used between the two analogous sets of drawings.

For a further, exemplary, example, any implement [e.g. a filament spool, or other type of implement (e.g. note the various implements shown in the above listed patents), etc.] attached to the bottom end (2a-2d) of the hand-held powered device (1a-1d) is removed. Then, as shown in FIGS. 11A-D, an appropriate threaded member 3a-3d, typically either a nut 3a/3c (FIGS. 11A & 11C) or a bolt 3b/3d (FIGS. 11B & 11D) with one or more appropriate, top and/or bottom washers 4, 5 can be used to connect, for example, an exemplary cultivator/cutter implement 10 to the exemplary, long handle, two-hand-held powered device 1a-1d.

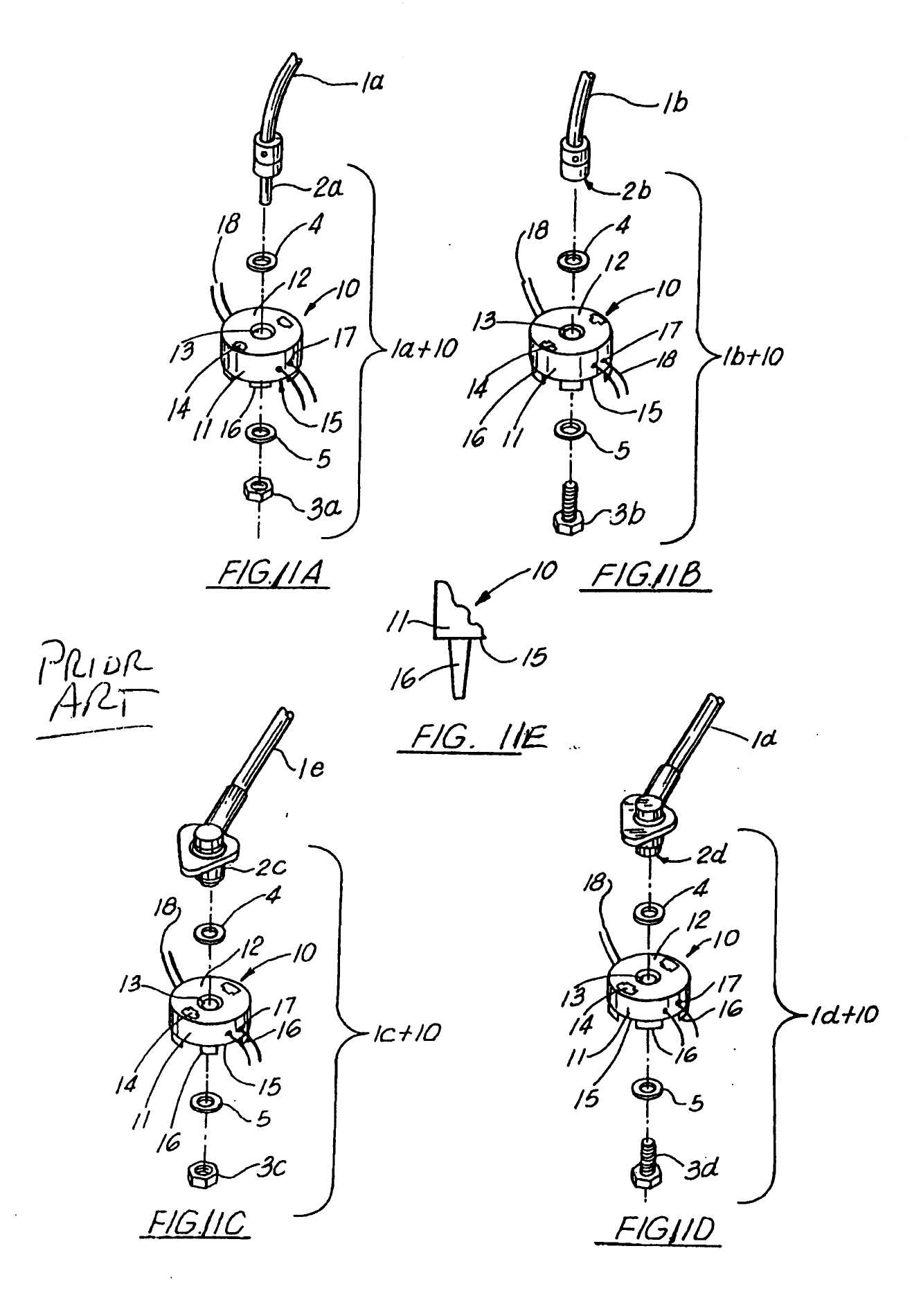

As can be seen in FIGS. 11A-D and in the '539 patent, an exemplary cultivator/cutter implement or substitute attachment 10 (see also the more advanced cultivator/cutter or trimmer attachment 20 of FIGS. 12A-12D) can include a cylindrically shaped body 11 with preferably generally a solid top 12 extending over most of its top with, for example, the exception of the central unit attachment opening 13 and the “snap-in,” “T” shaped openings 14 circumferentially spaced about the periphery of the top 12. Further open areas could be provided in the top 12, if so desired, as long as the top had the necessary structural integrity and strength. Although the body 11 is preferably exactly cylindrical, some flaring of the side wall may occur, for example, in the manufacturing process which causes the body to be substantially cylindrical, but not exactly cylindrical, in its over-all, exterior shape.

The curved side wall of the body 11 preferably is relatively thin, continuous and of constant thickness, although some deviation of the body's side wall is possible as long as the deviation(s) do not significantly impede the movement and penetration of the side wall down into the ground in the implement's cultivator action and as long as the side wall has the necessary structural integrity and strength. Additionally, peripherally spaced about its bottom 15 are a series of spaced, cultivator extensions tines 16, along with a series of dual opening or hole sets 17 through which the ends of cutting filament line segments 18 are placed for cutting functions. When it is desired to use the implement 10 as a filament line cutter, an appropriate number of line trimmer segments 18 are placed in the hole sets 17 as seen in FIGS. 11A-D, as further discussed in detail in the '539 patent in connection with FIGS. 24A & B of that patent, but as altered in accordance with the principles of the present invention.

The locking system, exemplary embodiments of the present invention include short, trimmer line filaments, of, for example, about ten to about fourteen (12-14″) inches in length, with twelve (12″) inches being exemplary, which can be used in, for example, weed cutters in place of the continuous filament on a spool, such as, for example, the spool 6 of FIGS. 9A & 9B. They can also be used in a special attachment disclosed in the three Jerez patents mentioned above, such as, for example, the cultivator/adapter 10 of FIGS. 11A-D or 12A-D.

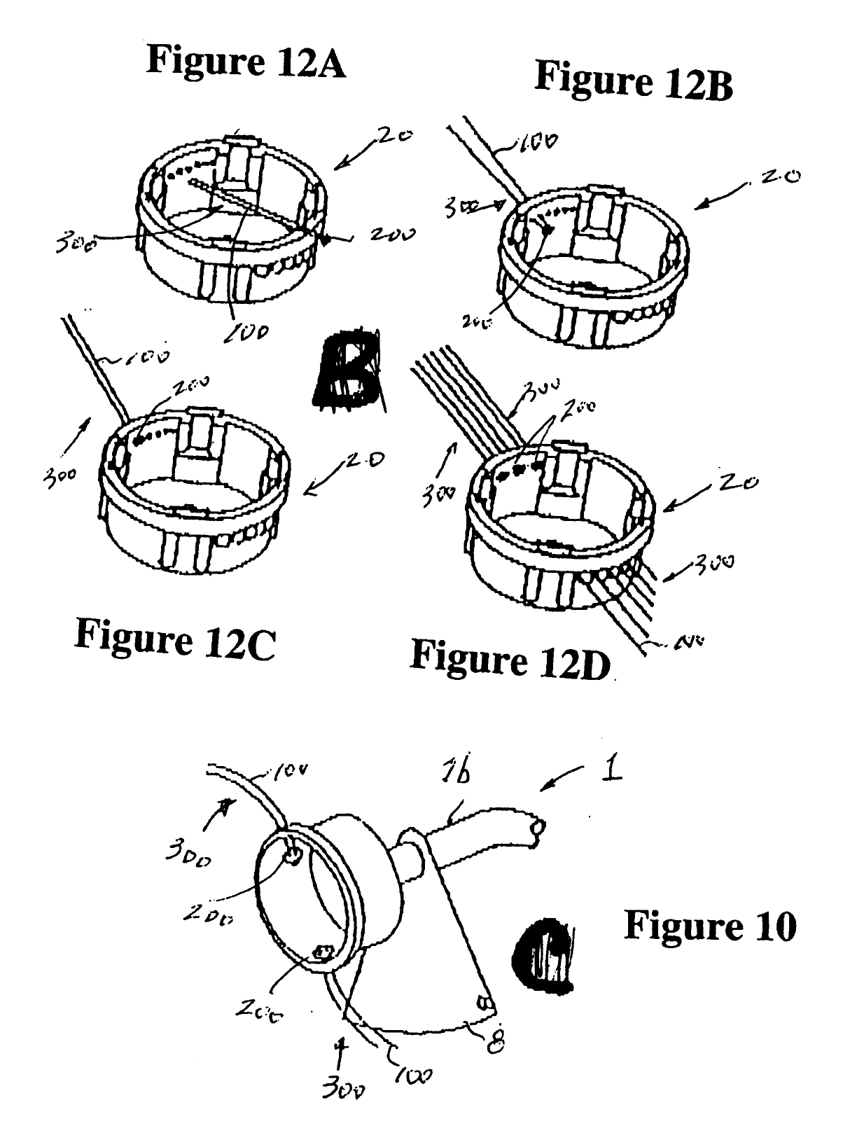

In its simplest version, the filament is simply cut and threaded through two holes in a special weed cutter head, for example, the exemplary cultivator/adapter 10 (FIGS. 9A & 9B). In the next simplest, preferred version, the filament is threaded through a button or button-like device (see FIGS. 1A-C), and the filament can be inserted through the normal trimmer line hole in a weed cutter head (see FIG. 10) and the button or button-like element holds the trimmer line or filament in place.

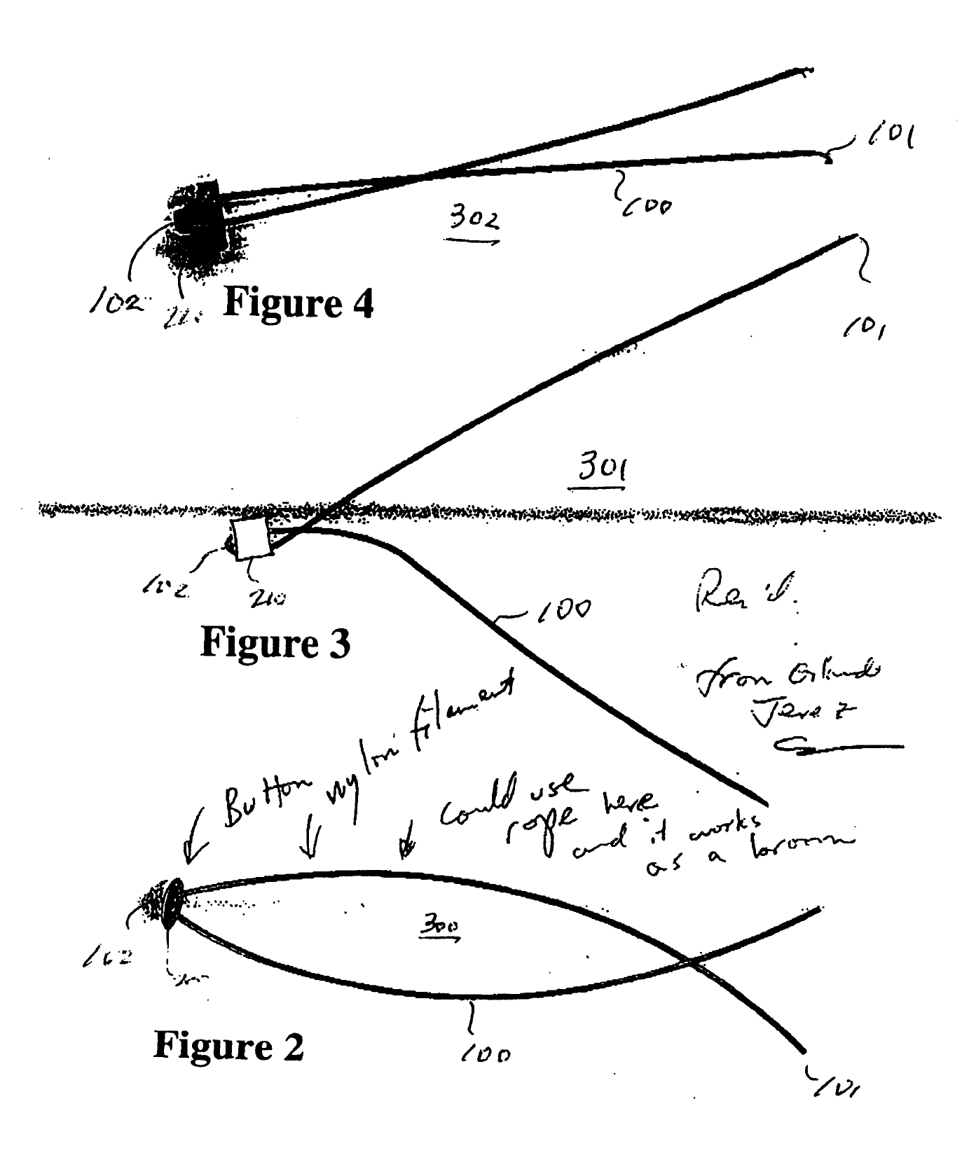

Exemplary variations of the filament holding buttons or button-like elements are shown in FIGS. 2-8.

An advantage of the button-held filament is that it is able to flex more easily than filament attached to a spool, such as, for example, the spool 6 of FIGS. 9A & 9B, and thus breaks less frequently.

These various embodiments will be described in connection with the figures hereof.

### Attachment of Line Filament to an Exemplary Locking Element

### FIGS. 1A-C

As can be seen in the sequential figures of FIGS. 1A-C, the distal ends 101 of a segment of trimmer line 100 initially are inserted (note dashed lines) into selected, side-by-side holes 201 in the button-like locking element 200, ultimately producing the joined line and locking element 300 of FIG. 1C. As can be seen in FIG. 1B, the locking element 200 can be slid up the line 100 until the mid-section 102 of the line is met or, alternatively or conjunctively, the line 100 pulled through the holes and out, until the mid-section is seated against the surface of the locking element 200.

As illustrated, the locking element 200 has at least two holes 201 through it for fitting and holding the trimmer line segment 100 or multiple pairs of holes, for example, four or two pair 201, 202, as illustrated, the latter allowing two segments of trimmer line to be added to the locking element 200.

After the line 100 and the locking element 200 are fully joined together to form the assembly 300, it should be understood from the drawings that the distal ends 101 and the adjacent sections of the trimmer line extend all on one side of the locking element, except for the mid-section 102 which is on the other side of the locking element at least generally in contact therewith.

Once assembled together to produce the joined line and locking element 200 of FIG. 1C (note also 300/301/302 in FIGS. 2-4), the assembly is ready to be added to holes in the rotatable head of a powered device, for example, those included in the weed cutters of FIGS. 9 & 11 producing the line locked assemblage of FIG. 10 and FIGS. 12C & 12D.

### Exemplary Locking Elements (FIGS. 2-8)

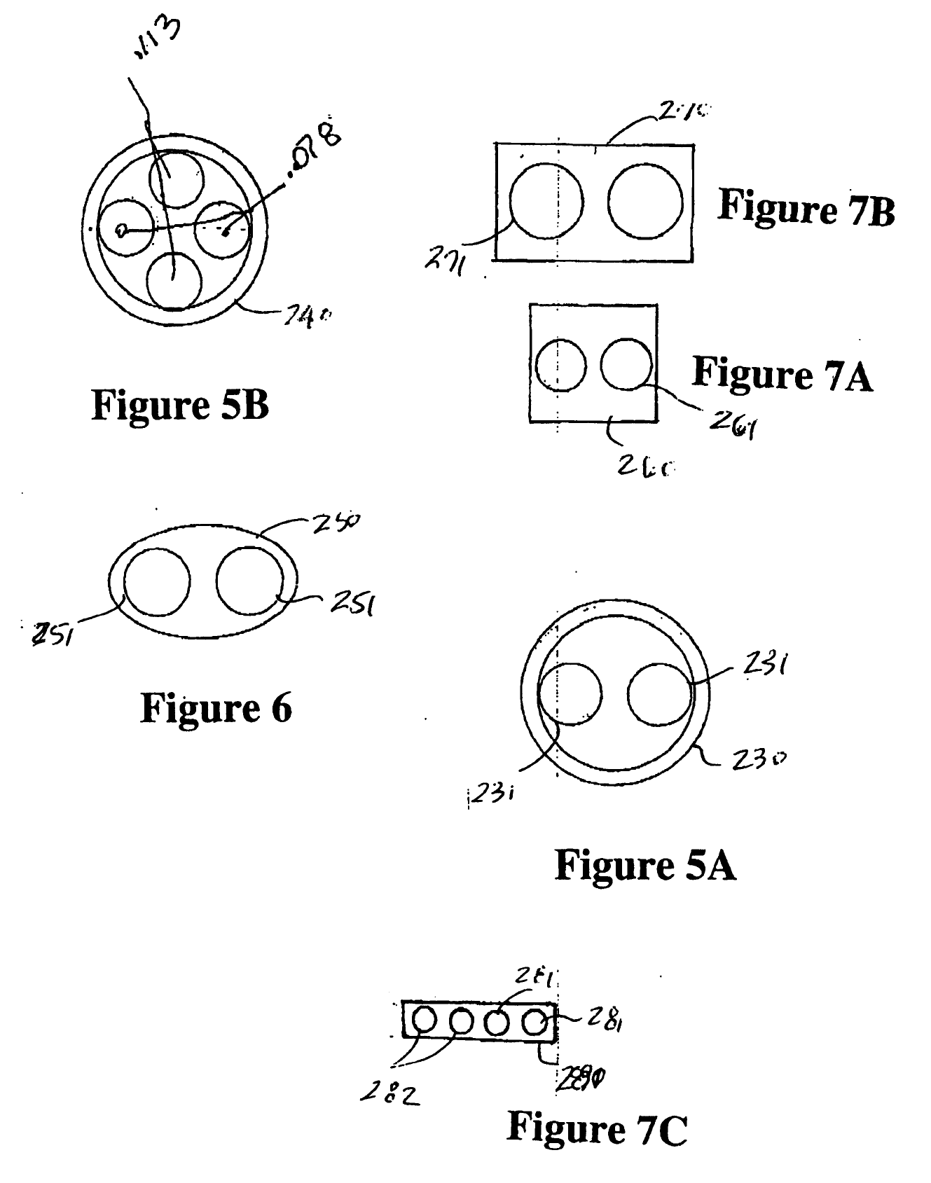

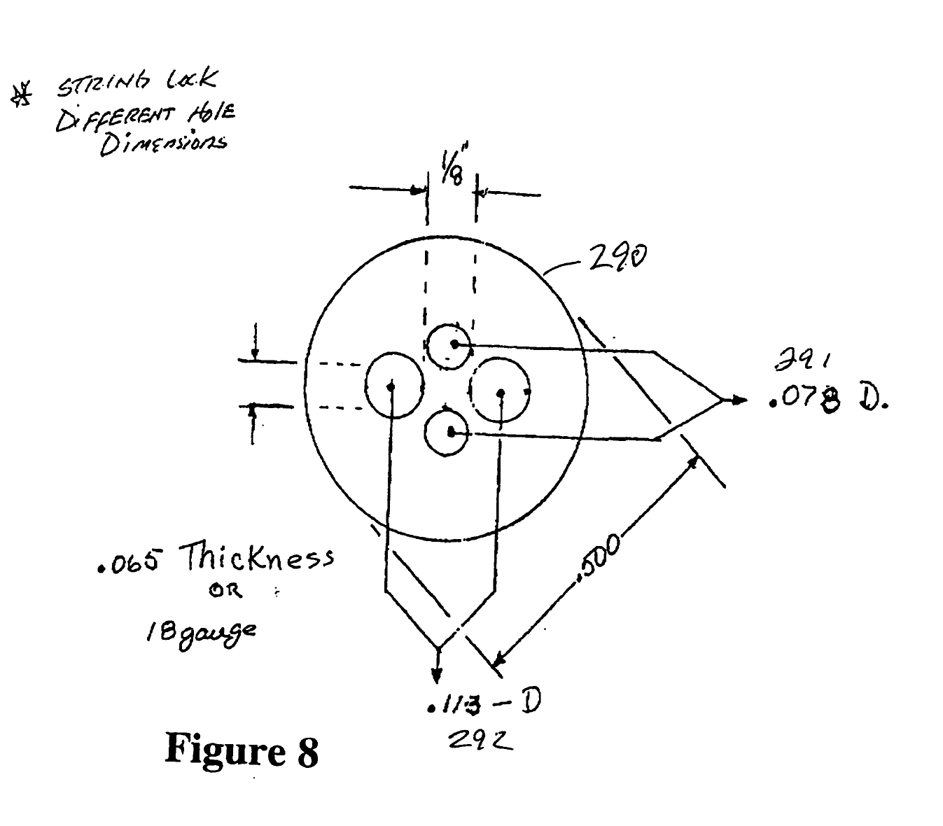

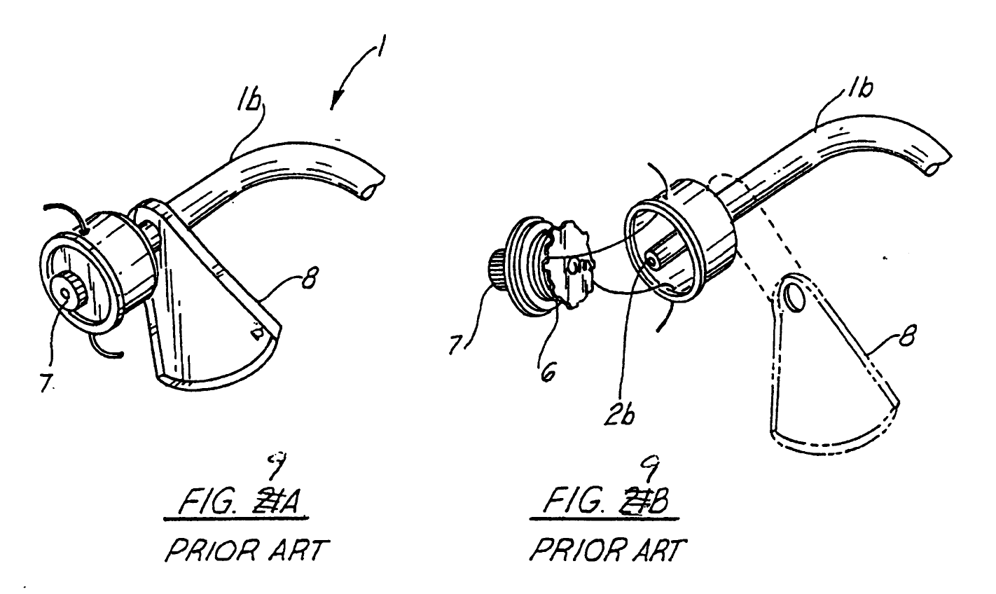

As can be seen in the drawings, various different, exemplary, button-like locking elements are disclosed herein. For example, the locking element 200 in FIGS. 1A-C is a relatively flat, circular, button-like structure with four holes forming two pair 201, 202 of side-by-side line holes; likewise with respect to FIG. 2, FIG. 5B (which also includes a peripheral strengthening ring) & FIG. 8. Also note the circular button-like structure 230 of FIG. 5A with a single pair of line holes 231, as well as the ovally shaped locking element 250 of FIG. 6 with its pair of holes 251.

For further examples, note the squared off button-like locking element 210 of FIG. 3, as well as the squared off or rectangular locking elements 260 & 270 of FIGS. 7A & 7B, respectively, with their two holes 261 & 271, respectively, and the quite elongated, rectangular locking element 280 with its two pair of holes 281 & 282 forming a total of four line holes.

With further reference to FIGS. 5B & 8, the overall diameter of the bodies of the locking elements 240 & 290 can be, for example, about a half an inch (0.500″), and an exemplary diameter for the first set of smaller diameter holes 291 can be, for example, seventy-eight hundreds of an inch (0.078″), while the diameter of the first set of larger diameter holes 292 can be, for example, one hundred and thirteen hundreds of an inch (0.113″). An exemplary thickness of the flat part of the body can be about sixty-five hundredths of an inch (0.065″) made of eighteen (18) gauge plastic material.

It is noted that many additional designs are possible for the button-like locking elements in addition to those particularly disclosed and illustrated herein. For example, many additional designs and configurations are shown in the drawings of the parent provisional application 06/402,518, all of which are incorporated herein by reference. Applicant reserves the right to add additional drawings or figures from the provisional patent application to this specification. Of course, even the many more designs and configurations illustrated in the provisional application were not intended to be exhaustive, although quite extensive, of all of the possible designs for the locking elements of the present invention.

### Final Assembly (FIGS. 10 & 12A-D)

With reference again to FIGS. 9A & 9B, after the spool 6 and its continuous filament line is completely removed from the powered device, the distal line ends 101 of an assembled line 100 and its associated button-like locking element combination 300 (301, 302) is inserted through a selected one of each of the remaining filament holes in the cylindrical, rotatable head of the powered device (e.g., a weed trimmer or cutter). Although the rotatable head typically has only one filament line opening on a side, requiring that both distal ends 101 of the assemblage 300 are both inserted through the same hole, the body of the button-like locking element 200 securely holds and prevents the mid-section 202 of the line 100 from moving through that opening, locking and holding that line 100 to the rotatable head, even when the powered device drives the head at a relatively high speed in the weed cutting operation.

Alternatively, again with reference to FIGS. 11A-11D, the powered device may have an attachment such as the cultivator/cutter 10 or the more sophisticated cultivator/cutter 20, rather than the spool 6. As indicated in sequential FIGS. 12A-12D, the final assembly or attachment step is comparable to that described in connection with FIG. 10.

As can be seen in FIG. 12A, the distal ends 101 of an assembled line (100) element (200) assembly 300 are both inserted into a first hole (or, alternatively, two, side-by-side holes) in the outer wall of the cylindrically shape attachment with the balance of the line segment then pulled completely through as shown in FIG. 12B, until the button-like locking element 200 contacts the inner side of the wall (see FIG. 12C), preventing any further movement of the line through the wall, locking the wall and the line together even during the relatively high speed rotation of the attachment head as it is used to, for example, cut weeds.

Because the more sophisticated attachment 20 has multiple numbers of line holes at each side, a relatively large number of line/locking-element assemblies 300 can be added to it, if so desired, as illustrated in FIG. 12D.

For an exemplary, alternative application to weed cutting, it is noted that the line selected for adding to the rotatable head could be, for further example, highly flexible string instead of the relatively hard filament line 100, allowing the powered device to then be used, for example, as a broom or blower, etc.

### CONCLUSION

Thus, the present invention provides a very handy, supplemental device or product with multiple uses.

One of the biggest problem with the current, “prior art” weed trimmer designs are the functional inadequacies of the nylon trimmer line and the system or mechanism that feeds the line. The line frequently breads off and usually draws back into the head causing in some instances the trimmer to jam. In other instances it is difficult to advance or feed trimmer line through; the user has to “bump” to feed the line and in some cases has to take apart the head and manually re-spool the line due to entanglement. Also, some trimmer attachments have rotating blades that are dangerous and not effective and serve only a single, functional purpose.

The present invention in many of its aspects is the “ultimate” nylon string holder. It makes the nylon last longer. It also make the nylon rotate at the same time as the head, as well as secure the nylon line. It also provides a faster and easier nylon string insertion and removal methodology.

The exemplary methodology for the exemplary embodiments of the present invention includes either using pre-cut, trimmer line segments of, for example, twelve (12″) inches in length or taking a larger supply of line and cutting from it such lengths. Each trimmer line segment is then bent in half back unto itself, preferably making sure that the bent over portions are of equal length. The two end tips of the trimmer line segment are then inserted into selected ones of the locking element holes, either concurrently or sequentially.

The distal ends 101 of the trimmer line 100 with the button-like locking element (200-290) attached (300) at its mid-section is then inserted from the interior into at least a selected one or more preferably two, adjacent openings, if available, in the outer, circular wall of the rotatable head (head previously holding spool 6, 10 or 20) of the user's powered trimming machine with the distal tips and the adjacent sections, that is, most of the trimmer line segment 100 extending out of the head.

The procedure is then repeated for the at least some, preferably all, of the remaining filament holes in the head with the total number of the supplemental devices 300 symmetrically or equally spaced about the axis of rotation of the rotatable head.

Of course, if the powered trimming machine is of the spool type, the spool 6 needs to be removed from the machine's rotatable head before adding the supplemental devices 300 to the head's eyelets.

Some weed trimmers of the spool & “bump” type have channel(s) instead of eyelets. In such cases, the supplemental devices 300 are added as before, but then the “bump” will need to be reattached to the trimmer ensuring that the supplemental devices stay in place during use. In some other trimmer designs it will be necessary to replace the “bump” as well as the spool to keep the supplemental devices 300 in place.

### Exemplary Dimensions & Other Particulars

It should be understood that, when the rotatable heads of the powered devices are rotatably driven at the relatively high speeds that these types of devices produce, which, for example, are rotated at about eight thousand (8,000 rpm) revolutions per minute [typically not to exceed about ten thousand (10,000 rpm) revolutions per minute], the main body of the line 100 extending on the outside of the rotatable heads become extended out in a radial direction during the weed trimming or other type operation. Additionally, with the great amount of centrifugal force that is created by such high speed rotation, the outwardly directed surface of the locking element(s) 200 become even more locked or otherwise held to the inner surface(s) of the then rotating head.

It is noted that, although flat, round, button-like elements 200 have been found to work well in actual use and can be manufactured at reasonable cost, more complex shapes are possible, as noted above. For example, the locking elements could have a curved outward surface to mate in face-to-face engagement with the inner surface of the typically cylindrically shaped work heads of the powered tools.

It also should be understood that typical dimensions for weed cutting filaments 100 which can be used as discussed above with the locking elements 200 are ones preferably made of flexible nylon having diameters of about eight hundredths (0.080″) of an inch or otherwise within a range of about a five hundredths of an inch to about one hundred and five thousandths (0.050″-0.105″) of an inch, typically of a length of about ten to about fourteen (10″-14″) inches, with twelve (12″) inches being exemplary. The exemplary diameters of the side filament openings in the spool 6 typically are about one hundred and twenty-five thousandths to about one hundred and thirty thousandths (0.125″-0.135″) of an inch, and the exemplary diameter of the filament openings in the special, attachment heads 10/20 typically are about one hundred and twenty-five thousandths (0.125″) of an inch.

Of course, as the diameters of the filaments to be used substantially change, so possibly will the sizes of the locking openings 201/202 change, although the locking openings can be made sufficiently large to handle most, if not all, filament sizes that might be used. Substantial flexibility of size is allowed is allowed in the preferred designs by the use of two, associated openings 201 and/or 202, respectively, with the filament being used at its middle in a “U” shaped configuration as it inter-nests with the inner side of the locking element 200 and with the distal ends of the filament line extending radially out from the outer surface of the locking element a substantial distance of preferably about twelve (12″) inches.

It is also noted that, although the user can insert the filament 100 into the locking element 200 as shown in FIGS. 1A-1C, that is, both filament ends 101 concurrently, the filament can also be inserted sequentially into to the openings 201 or 202 by inserting one of the filament ends 101 through one of the opening and, for example, when the mid-section is reached, inserting the other filament end through the other respective opening, in essence, doubling the filament 100 back upon itself preferably equidistantly.

Of course, the width and height (or diameter) size of the locking elements 200 must be sufficiently large so that they cannot be pulled through the filament openings and be of a size that accommodates the desired filament openings 201 (202), etc. through it. The thickness and material of the locking element 200 must provide sufficient strength to keep it from breaking during normal use, either in the handling of it, the insertion of the filament into it and during high speed rotation. Heat treated metal has been found to be a suitable, exemplary material.

Of course, the foregoing details are exemplary and/or preferred and are subject to some variation, as long as the basic purpose and intended function of the devices are reasonably maintained.

Once the filament line segment 100 wears out, the locking element 200 typically is re-usable and can be put back into service with new piece(s) of filament line section inserted into it for weed cutting use (including, for example, undesired grass length trimming).

It should be understood that the foregoing dimensions, materials, variations and alternatives, etc., are merely exemplary, and many other changes are possible within the teachings of the present invention.

Thus, it is further noted that the embodiments of the universal, trimmer ling lock systems described herein in detail for exemplary purposes are of course subject to many different variations in structure, design, application and methodology. Because many varying and different embodiments may be made within the scope of the inventive concept(s) herein taught, and because many modifications may be made in the embodiments herein detailed in accordance with the descriptive requirements of the law, it is to be understood that the details herein generally are to be interpreted as illustrative and not in a limiting sense.

Thus, the foregoing embodiments are presented by way of example only; and the scope of the present invention is to be defined only by the following claims read in light of the specification.

1. A supplemental device for an apparatus for trimming weeds using rotating, axially directed trimmer line, the apparatus having a rotatable, powered head with a side wall with at least one side hole through it through which radially directed trimmer line can be inserted, comprising:
a button-like element for holding trimmer line attached through the side wall hole of the weed trimming apparatus, said button like device having at least four holes, with a set of first and second holes of a first diameter for holding trimmer line of a certain diameter, and a second set of third and fourth holes of a second, different diameter from the first and second holes for holding trimmer line with a different diameter than said certain diameter, the trimmer line being of a length and strength to cut weeds when said button-like element and the filament is placed on a powered, weed trimming machine.

2. The supplemental device of claim 1, wherein:
said button like device has at least four holes, with a set of first and second holes of a first diameter for holding trimmer line of a certain diameter, and a second set of third and fourth holes of a second, different diameter from said first and second holes for holding trimmer line with a different diameter than said certain diameter.

3. The supplemental device of claim 2, further comprising:
trimmer line threaded through at least one set of said holes with sections of the trimmer line being inserted through a pair of said four holes on one side of said button-like element and the mid-section of the trimmer line being on the other side of said button-like element, the line being of a radial length to cut weeds when the apparatus is placed on a powered, weed trimming machine.

4. The supplemental device of claim 1, wherein:
said button like device has a body which is circularly shaped.

5. The supplemental device of claim 1, wherein:
said button like device has a body which is rectangularly shaped.

6. The supplemental device of claim 5, wherein:
said rectangularly shape forms a square.

7. The supplemental device of claim 5, wherein:
said rectangularly shape forms an elongated rectangle with four, in-line holes in it.

8. The supplemental device of claim 1, wherein:
said button like device has a body which is ovally shaped.

9. Supplemental apparatus for trimming weeds with a powered, weed trimming machine having a rotating head with at least one head trimmer line opening though it extending from a head inner side to a head outer side, comprising:
a button-like locking element with at least two holes through it from a locking element inner side to a locking element outer side; and
trimmer line, having a mid-section and tip ends, with said trimmer line being threaded through said holes in a “U” shaped, doubled-over fashion with the mid-section of the line forming substantially a “U” shape on said inner side of said locking element and the tip ends of the line extending out to and extending past said outer side of said locking element, the trimmer line being of a length and strength to cut weeds when said locking element with its trimmer line are placed on the head of the weed trimming machine, with the trimmer line inserted through the head line opening to extend outwardly of the rotating head with the outer side of said locking element located against the inner side of the rotating head.

10. The supplemental apparatus of claim 9, wherein:
said button like locking element has at least four holes, with a set of first and second holes of a first diameter for holding trimmer line of a certain diameter, and a second set of third and fourth holes of a second, different diameter from said first and second holes for holding trimmer line with a different diameter than said certain diameter.

11. The supplemental apparatus of claim 9, wherein:
said button like locking element has a body which is circularly shaped.

12. The supplemental apparatus of claim 11, wherein:
said button like locking element has a circular body having a diameter of about a half (0.5″) of an inch.

13. The supplemental apparatus of claim 9, wherein:
said button like locking element has a body which is rectangularly shaped.

14. The supplemental apparatus of claim 13, wherein:
said rectangularly shape forms a square.

15. The supplemental apparatus of claim 13, wherein:
said rectangularly shape forms an elongated rectangle with four, in-line holes in it.

16. The supplemental apparatus of claim 9, wherein:
said button like locking element has a body which is ovally shaped.

17. A method of converting a powered, weed trimming machine
having a spool of continuous filament for trimming weeds and the like located in a rotatable head into which the spool fits, with the end of the continuous filament typically extending out through an opening in the side wall of the rotatable head
to one using at least one segment of trimming line of approximately about ten to about fourteen (10″-14″) inches in length for the weed trimming function in place of the continuous filament, comprising the steps of:
manually attaching the segment of trimming line to a button-like locking element having at least two holes through it by inserting the distal ends and adjacent lengths of trimming line through said two holes out onto one side of said locking element with the mid-section of the trimming line located on the other side of said locking element in contact therewith; and
after manually removing the spool from the rotatable head, inserting the distal ends of the assembled trimming line and locking element and adjacent section of the line segment via the interior side of the rotatable head through the opening in the rotatable head until the locking element becomes in juxtaposition to the inner side of the wall of the rotatable head, with the locking element preventing the line from moving further out of the opening, with the distal end and adjacent sections of trimming line extending radially outwardly from the rotatable head for weed cutting like action when the rotatable head is rotationally driven at a relatively high weed trimmer type speed.

18. A method of converting a powered, weed trimming machine having a rotatable head having at least two, radially directed, filament holes through it spaced about it periphery spaced apart one hundred and eighty (180°) degrees, comprising the steps of:
(a) separately manually attaching a number of segments of trimming line each to a respective one of button-like locking elements, each locking element having at least two holes through the locking element, by inserting the distal ends and adjacent lengths of the trimming line segment through said two holes out onto one side of said locking element with the mid-section of the trimming line segment located on the other side of said locking element in contact therewith;
(b) repeating step “a” for a total number of segments equal to at least one half of the number of radially directed, filament holes in the rotatable head;
(c) inserting via the interior side of the rotatable head the distal ends of the assembled trimming line and locking element and adjacent sections of the line segment through selected ones of the radially directed, filament holes until the locking element becomes in juxtaposition to the inner side of the wall of the rotatable head, with the locking element preventing the line from moving further out of the rotatable head, with the distal end and adjacent sections of trimming line extending radially outwardly for weed cutting action when the rotatable head is rotationally driven at a relatively high trimmer type speed; and
(d) repeating step “c” a number of times using different ones of the radially directed, filament holes.

19. The method of claim 18, wherein said locking element is circular with at least two sets of opposed, two filament holes through it, two of the same diameter and the other two with a different but equal diameter to each other; and wherein there is included in connection with step “a” the step of:
inserting two different size filament line segments into each set of two holes.

20. The method of claim 18, wherein said locking element is circular with at least two sets of opposed, two filament holes through it, two of the same diameter and the other two with a different but equal diameter to each other; and wherein there is included in connection with step “a” the step of:
inserting only one size filament line segment into a selected one set of two holes and using it to trim weeds and the like.
